(19) United States
(12) Patent Application Publication
(10) Pub. No.: US 2025/0239176 A1
(43) Pub. Date: Jul. 24, 2025

(54) Modular Topography System for Boards Handles and Gripping Surfaces and Related Methods of Use

(71) Applicant: Chad Sterling Priest, Fenton, MI (US)

(72) Inventor: Chad Sterling Priest, Fenton, MI (US)

(21) Appl. No.: 19/174,904

(22) Filed: Apr. 9, 2025

Related U.S. Application Data
(60) Provisional application No. 63/640,057, filed on Apr. 29, 2024.

(51) Int. Cl. G09B 19/24; A63B 60/14; A63C 17/00; G08B 7/00

(52) U.S. Cl. CPC G09B 19/24; A63C 17/0006; G08B 7/00; A63B 60/14; A63C 2203/22; A63C 2203/24

(57) ABSTRACT

A modular accessory system for altering surface topography on boards, handles, and other contact platforms used in sports, fitness, and consumer applications. The system comprises attachable elements that vary in shape, texture, height, or material and are positioned in contact zones to modify grip, traction, slide, or tactile feedback. Elements are secured via adhesives, fasteners, magnetic couplings, hook-and-loop systems, or UV-curable resins. The system supports modular customization across diverse platforms, including but not limited to sporting equipment, recreational boards, tools, gaming devices, fitness gear, and wearables. Users can selectively place, reposition, or replace accessories to suit maneuvers, ergonomic needs, or training goals. Optional inserts or embedded electronics—such as sensors, lights, or haptics—enable real-time feedback, interactivity, or performance tracking. The system allows post-manufacture integration and interchangeable use across platform types, transforming passive surfaces into adaptive, performance-enhancing, and feedback-capable interfaces for training, recreation, rehabilitation, or interactive use.

### CROSS-REFERENCE TO RELATED APPLICATIONS

This application claims priority to U.S. Provisional Patent Application No. 63/640,057, filed on Apr. 29, 2024, the contents of which are hereby incorporated by reference in their entirety.

### FIELD OF THE INVENTION

The present invention relates to modular surface modification systems, and more specifically to modular accessories configured for attachment to boards and gripping surfaces to alter surface topography for improved grip, control, and performance in sports, fitness, and ergonomic applications.

Such accessories may be used to enhance grip, tactile feedback, control, and performance across various types of sporting, recreational, and fitness equipment.

As used herein, the term “Modular Topography System” refers to a configurable arrangement comprising one or more modular topography accessories and associated components or methods that together enable user-driven surface customization.

As used herein, the term “topography” refers broadly to any surface contour, shape, profile, or structure that influences tactile interaction, friction, grip, or sliding behavior, and includes alternative descriptors such as modular grip interfaces, surface-modifying elements, or tactile control geometries.

A “surface-modifying feature” refers to any physical structure, protrusion, indentation, texture, or embedded element configured to alter the user's tactile experience or mechanical interaction with the surface, including but not limited to dimples, ridges, bumps, channels, spikes, or cavities, and comprising one or more geometric or non-uniform surface features adapted to influence tactile response, grip behavior, or ergonomic engagement.

The term “tactile interface profile” means the external geometry or contact shape presented to the user's hand, foot, or wearable gear, which may include convex, concave, angled, or compound forms and is intended to influence pressure distribution, comfort, grip security, or motion responsiveness.

A “contact zone” refers to any area of a board, handle, or surface that is physically engaged by a user during operation, including foot placement zones, hand grips, edges, and strike points.

As used herein, the term “functional interaction zone” refers to a portion of a platform surface—such as a grip, handle, or contact region—configured to interface with a user's hand, foot, or wearable equipment during operation, and selected to enhance performance, control, or feedback through localized modular attachment.

A “modular interface system” encompasses any configuration of interchangeable or reconfigurable elements designed to attach to an existing platform and modify its topographical or tactile characteristics.

A “gripping surface” or “grip zone” means any surface area where traction or ergonomic control is desired, such as the shaft of a barbell, bat handle, pull-up bar, or dumbbell grip.

As used herein, the term “customized” includes user-selectable positioning, selection from a set of modular forms, or factory-or post-manufacture adaptations configured to suit ergonomic or functional interaction zones.

An “interchangeable insert” refers to any removable component placed within a cavity or pocket of the modular element to modify its visual, functional, or tactile behavior—examples include wax blocks, foam cushions, LEDs, sensors, or rubber pads.

A “UV-curable resin interface” refers to any adhesive or bonding mechanism activated by ultraviolet light (typically in the 365-405 nm wavelength range) to enable secure affixation between the modular accessory and the substrate surface, optionally through transparent or translucent components that allow light penetration.

These systems are designed to not only modify the physical surface geometry but also optionally include intelligent feedback mechanisms to support real-time user coaching, activity tracking, or motion correction.

The invention also encompasses training and feedback systems that provide real-time guidance or alerts to the user through visual, tactile, or motion-based cues. This includes applications in sports coaching, VR or gaming interaction, posture correction, and rehabilitation exercises where correct grip, stance, or alignment may be confirmed or corrected by the accessory.

These definitions are provided for clarity and may be interpreted inclusively and non-limitingly to cover functionally equivalent structures or variations thereof.

### BACKGROUND OF THE INVENTION

Conventional boards, grips, and fitness platforms—such as skateboards, surfboards, hand tools, exercise equipment, and bats—typically feature static surface treatments such as grip tape, molded rubber, or textured padding. These solutions are fixed in shape, lack modularity, and offer limited adaptability across users, applications, or changing environmental and ergonomic conditions.

Existing “smart” grip products, such as smart baseball bats or sensor-equipped fitness handles, may incorporate embedded electronics for tracking swing metrics or grip pressure. However, these systems are typically integrated into a single device, lack modularity, and are not transferable between platforms. They also often require specialized manufacturing or are proprietary to one piece of equipment, limiting reuse, scalability, or after-market adaptability.

Further, these existing solutions generally do not offer customizable topographical features—such as raised or recessed tactile elements—or allow users to reconfigure grip zones based on personalized needs, performance styles, or sport-specific techniques.

There remains an unmet need for a modular, reconfigurable surface-enhancement system that allows users to physically and functionally customize contact surfaces while optionally integrating sensory feedback mechanisms (e.g., LEDs, haptics, or sensors).

None of the existing products provide a modular surface-feedback interface that combines all of the following key features:
Configurable for multisport or cross-industry use: Unlike traditional grip solutions that are designed for a single activity (e.g., grip tape for skateboards or molded grips for fitness tools), the present invention enables cross-platform compatibility. Its modular design supports use across a wide range of sports, rehabilitation tools, consumer electronics, ergonomic devices, and occupational equipment—allowing the same core system to be adapted for skateboards, surfboards, baseball bats, gaming controllers, fitness handles, and even wearable devices.
Capable of post-manufacture integration: Most existing surface modification systems are built into the product at the factory and are not easily modified or upgraded by the end user. In contrast, the invention enables retroactive customization using interchangeable elements that can be affixed post-manufacture via adhesive, fasteners, or UV-curable resin. This means users can transform standard equipment into a performance-optimized or feedback-capable tool without the need for specialized tools or fabrication processes.
Includes optional embedded electronics for real-time performance feedback, training optimization, or ergonomic correction: While some smart equipment includes sensors or embedded electronics, they are typically hardwired into the product and limited to a single function or form factor. The present invention integrates electronics such as pressure sensors, motion detectors, haptic modules, LEDs, or wireless transmitters into modular, swappable units. These electronics provide real-time sensory feedback—visual, tactile, or auditory—to guide posture, detect incorrect grip or form, track performance metrics, or reinforce movement patterns, and may even communicate across multiple accessories for synchronized responses.

The present invention addresses these limitations by introducing a system of modular topography accessories designed to be interchangeable within and adaptable across a wide range of platforms. While not all implementations require cross-platform compatibility, the system's architecture supports interchangeable use where desired.

### SUMMARY OF THE INVENTION

The invention provides a modular accessory system for selectively modifying the topography—that is, the surface-modifying geometry or tactile interface profile—of boards, handles, and other gripping surfaces. Each accessory comprises a body with defined geometry, material composition, and optional features that influence grip, friction, tactile response, slide characteristics, or surface control.

The modular elements are configured to be affixed to contact zones on sport, fitness, ergonomic, or interactive equipment, including—but not limited to—skateboards, surfboards, snowboards, balance boards, scooters, dumbbells, gaming controllers, and exercise platforms. Securement methods may include adhesives, mechanical fasteners, magnetic couplings, hook-and-loop systems, or UV-curable resins. Some accessories may use UV-transmissive materials to enable precise bonding through in-place curing when exposed to ultraviolet light.

The system allows users to customize surface configurations to suit specific performance goals, training routines, terrains, user preferences, or ergonomic needs. The invention further encompasses related methods of use, including placement, removal, repositioning, and user interaction with the accessories via hands, feet, footwear, or wearable equipment to optimize control, feedback, and responsiveness.

Accessories may be tailored for branding, personalization, or consumer electronics applications using platform-specific contours, interchangeable inserts, or visual overlays. In some embodiments, accessories may include embedded electronics-such as sensors, lights, haptic modules, or communication devices—to provide real-time grip feedback, posture correction, training cues, or system interaction via wireless communication.

Materials may include polymers, composites, thermoplastics, foams, metals, rubber, or laminated hybrids. Surface profiles may be convex, concave, flat, or angular, and may be configured to interact with a user's body, terrain features, or equipment elements. The system may be implemented during manufacture or retrofitted as an aftermarket solution, and may be sold as a kit with installation tools, placement guides, and interchangeable elements.

### BRIEF DESCRIPTION OF THE DRAWINGS

FIG. 1 shows a top-down view of a Modular Topography Accessory including a body with an upper surface, lower surface, and outer surface profiles. Surface-modifying features include protrusions, dimples, holes, cutouts, and cavities adapted to modulate traction, grip, or mounting configuration.

FIG. 2 is a perspective view of the Modular Topography Accessory of FIG. 1, illustrating the spatial relationship of the body's features and highlighting variations in shape, size, and profile.

FIG. 3 is a side view of the Modular Topography Accessory showing bottom protrusions, surface contours, and optional mounting elements such as a screw and adhesive interface.

FIG. 4 is a cross-sectional view taken along line A-A of FIG. 1 showing internal cavities, holes, cutouts, and molded or insertable elements embedded within the body.

FIG. 5 is a bottom view of the Modular Topography Accessory highlighting bottom-mounted cavities, identification markings, and mounting or sliding enhancements.

FIG. 6 is a perspective view of a square-shaped Modular Topography Accessory variant, illustrating a modified body geometry and standard surface-modifying features.

FIG. 7 shows a top-down view of another Modular Topography Accessory variation with a distinct body shape and multiple holes and dimples adapted for grip adjustment or material inserts.

FIG. 8 presents a perspective view of a Modular Topography Accessory with concave and convex outer surface profiles designed to assist with specialized trick execution or directional control.

FIG. 9 is a top-down view of a Modular Topography Accessory featuring an elongated hole and cavity that enable sliding repositioning and extended mounting flexibility.

FIG. 10 is a side view of the Modular Topography Accessory of FIG. 9 showing multiple outer surface profiles adapted to interact with riding terrain or obstacles.

FIG. 11 is a bottom view of a Modular Topography Accessory with a Quick Release system (part 1 of 2), including tab cutouts, cavities, and bottom protrusions for mechanical engagement.

FIG. 12 is a bottom perspective view of a mating Quick Release component (part 2 of 2) including locking tabs, mounting hole, and bottom protrusions contoured to mate with FIG. 11.

FIG. 13 is a cross-sectional view of the assembled Quick Release system of FIGS. 11 and 12 showing mating structures, traction elements, and embedded inserts.

FIG. 14 is a side view of the Quick Release part 2 of 2 mounted with a screw, showing multiple locking tabs, bottom protrusions, and structural alignment with FIG. 11.

FIG. 15 is a cross-sectional view of a Modular Topography Accessory incorporating internal electronics including LEDs, a battery, motherboards, mirror, lens, switch, USB port, and a waterproof bottom plate.

FIG. 16 is a bottom view of a skateboard deck with multiple Modular Topography Accessories mounted underneath, shown in relation to trucks and wheels for slide and obstacle interaction.

FIG. 17 is a top view of a skateboard deck with Modular Topography Accessories mounted on the upper surface, with or without griptape, to enhance grip and trick initiation.

FIG. 18 is a side view of a skateboard deck with accessories mounted on both upper and lower surfaces to enable simultaneous traction enhancement and sliding performance.

FIG. 19 is a perspective view of a skateboarder mid-trick using a board equipped with Modular Topography Accessories, illustrating their interaction during flip or slide maneuvers.

FIG. 20 is a perspective view of a Quick Release variant using a threaded screw mechanism integrated into the inner shell of the Modular Topography Accessory.

FIG. 21 is a perspective view of another Quick Release variant using a threaded screw interface in the outer shell of the Modular Topography Accessory, providing an alternative to tab-based locking.

FIG. 22 is a top and side perspective view of a surfboard platform with Modular Topography Accessories including raised arch pads, concave heel wells, and wax-compatible inserts arranged in foot placement zones.

FIG. 23 is a perspective view of a fitness handle or dumbbell equipped with Modular Topography Accessories positioned in the grip zone, including contoured inserts and textured overlays adapted to enhance grip, comfort, and tactile control.

FIG. 24 Top and side perspective views of a training handlebar equipped with modular grip accessories positioned in user contact zones, each containing integrated pressure sensors and electronics for real-time posture and force feedback.

FIG. 25 Perspective view of a baseball bat with modular grip accessories featuring finger-aligned surfaces and embedded electronics for feedback. A top-mounted sensor and a connected mobile device illustrate real-time swing analysis and training use.

### DETAILED DESCRIPTION OF THE INVENTION

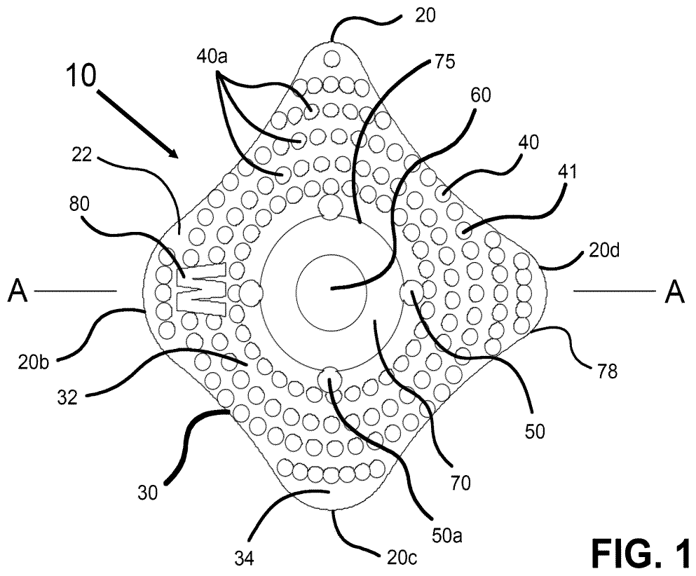

Referring to the accompanying drawings, where similar elements are denoted by like reference numerals, FIGS. 1-25 illustrate various embodiments of the Modular Topography Accessory System.

The invention provides a customizable system for enhancing or reducing traction, grip, tactile response, or slide on the top and bottom surfaces of a wide range of platforms. These include—but are not limited to—skateboards, surfboards, snowboards, fitness equipment, tools, exercise bars, gaming controllers, wearable devices, athletic footwear, or protective gear. While several figures illustrate skateboard decks, the invention is not limited to this platform and may be applied across sports, rehabilitation, consumer electronics, and ergonomic contexts.

The Modular Topography Accessory is engineered to dynamically interface with human biomechanics. The accessories optimize grip and surface interaction in response to foot or hand placement, directional forces, motion patterns, and user intent. Through real-time feedback or static reconfiguration, the system enhances user control, performance, safety, and comfort. Benefits include increased power transfer, balance, proprioceptive feedback, motion guidance, reduced slippage, and injury mitigation.

Unlike traditional grip systems—such as fixed griptape or molded rubber—the present system supports modular, ergonomic reconfiguration. Users can tailor their platform by adding or repositioning accessories to match training goals, trick preferences, terrains, disciplines, or rehabilitation stages. Fast-curing UV resin, interchangeable inserts, and modular template configurations allow both factory integration and post-manufacture upgrades.

Each accessory comprises a body featuring one or more surface-modifying features such as protrusions, dimples, cavities, cutouts, ramps, channels, holes, or shape variations. These features can be raised, recessed, convex, concave, or contoured to influence tactile feedback, directional control, and surface responsiveness.

Accessories are affixable using various attachment mechanisms, including, but not limited to:
Screws or mechanical fasteners
Pressure-sensitive adhesives
Hook-and-loop systems
Magnetic couplings
Quick-release locking elements
UV-curable resins

In certain embodiments, accessories are made from UV-transmissive materials (e.g., clear or tinted thermoplastics, polycarbonates, or silicones) that allow ultraviolet light (365-405 nm range) to penetrate and activate a UV-curable resin layer beneath. This enables precise bonding without mechanical intrusion and allows field installation or repositioning with minimal tools.

Customization may include shaping based on foot contour, hand grip, posture requirements, or platform geometry. Designs can be derived from user scans, biomechanical templates, or performance data. Modular templates and alignment guides can support intuitive placement. Accessories may also include edge clips or side-mounted engagement tabs to expand mounting versatility.

Inserts and overlays can be added for visual customization, tactile enhancement, or embedded function. These may include, but not limited to:
Rubberized pads for anti-slip grip
Wax blocks for controlled sliding
Foam cushions for vibration absorption
Printed logos or sponsor decals
QR codes or NFC chips for digital interactivity
Light-up elements for branding or training feedback

Consumer electronics applications may involve applying the system to gaming controllers, VR headsets, or wearable devices, where accessories enhance grip, reduce fatigue, or signal orientation. In such cases, conductive or capacitive overlays may preserve touch sensitivity or sensor interaction.

In further embodiments, the accessories include embedded electronics such as pressure sensors, accelerometers, gyroscopes, capacitive sensors, processors, haptic actuators, lighting modules (e.g., LEDs), switches, and wireless communication devices. These components allow for:
Detection of grip force or contact zone
Recognition of motion dynamics or rotational orientation
Alignment feedback for posture or movement correction
Data transmission to external devices (smartphones, tablets, or cloud platforms) via Bluetooth, BLE, Zigbee, Wi-Fi Direct, or NFC
Real-time user feedback through visual (lights), auditory (tones), or haptic (vibration) cues

Some configurations support inter-accessory communication. For example, a sensor in one accessory may detect incorrect grip or alignment and trigger a feedback response—such as light or vibration—in a second accessory mounted elsewhere on the platform. This multi-point coordination supports advanced training systems, rehabilitative feedback loops, or ergonomic alignment enforcement.

Examples of cross-platform use cases include, but are not limited to:
Skateboards: Trick initiation, foot placement, or dynamic grip adjustments
Surfboards: Concave inserts, wax-compatible pads, and heel wells for alignment and stability
Fitness handles & bars: Real-time grip force detection, symmetric posture feedback, and vibration cues
Tools or power equipment: Angle guidance, grip safety alerts, or fatigue prevention via haptics
Gaming & VR gear: Thumb rest contours, fatigue-reducing grips, orientation cues for immersive feedback
Rehabilitation tools: Ergonomic zones for posture training, biofeedback-based movement guidance

Construction techniques for the accessories may include, but not limited to injection molding, CNC machining, additive manufacturing (e.g., 3D printing), vacuum forming, die cutting, lamination, or hybrid manufacturing approaches. The system may be sold as modular kits comprising multiple accessory types, fasteners, adhesive solutions, UV-curing tools, templates, and installation guides, enabling both DIY and professional applications.

In summary, the Modular Topography Accessory System provides a versatile, customizable, and optionally interactive surface enhancement solution. Whether passive or sensor-enabled, the system allows users to transform any standard surface into a reconfigurable, performance-driven, and feedback-capable interface—adaptable for sport, recreation, rehabilitation, consumer electronics, or professional use.

FIG. 1 provides a top-down view of an exemplary Modular Topography Accessory (10), illustrating the Body (22) with an Upper Surface (75), Lower Surface (78), and varying Outer Surface Profiles (32, 34). The Body includes traction-modifying features such as Traction Protrusions (40, 40a, 50), Traction Reduction Dimples (41, 50a), Holes (60), Cutouts (80), and Cavities (70). These features may serve functional roles—such as enhancing grip or reducing friction—or act as receptacles for inserts, adhesives, or fasteners to secure the accessory to another object, such as a skateboard deck. The Body (22) may be constructed from plastics, wax, metal, wood, or composite materials.

The configuration, number, and placement of traction features are customizable. For example, Protrusions (40a, 50) may appear as bumps or ridges, while Dimples (41, 50a) provide reduced surface contact for sliding applications. Cavities (70) and Holes (60) may also serve to house materials or enable mounting mechanisms. The Outer Surface Profiles (32, 34) and Lower Surface profiles (30, including examples 20-20d) are not limited to a single curvature or contour and may vary to match specific riding or interaction needs.

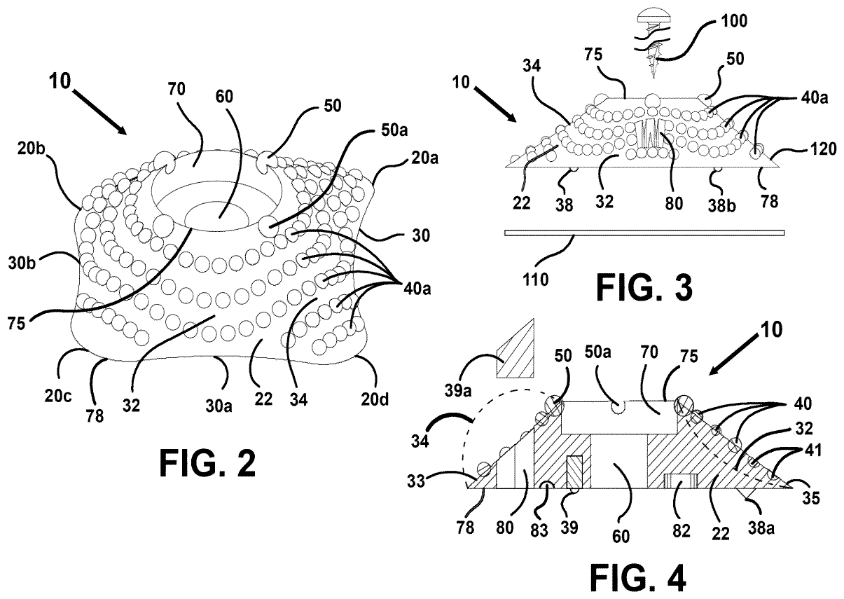

FIG. 2 offers a perspective view of the Modular Topography Accessory (10), consistent with FIG. 1 in overall construction. The figure illustrates how the same structural components—Body (22), Traction Protrusions (40a, 50), and customizable surface profiles—can be configured for distinct use cases. Alternate configurations, such as those shown in FIGS. 6-10, highlight the invention's adaptability in shape, size, and surface detail, each contributing to varied traction, sliding, or mounting characteristics.

Wax-compatible geometries, surface texture variation, and material combinations enable tailored performance. Attachment methods may include mechanical fasteners (e.g., Screws), adhesive products, or structural features like Cutouts or Cavities that secure the accessory to surfaces with or without additional hardware.

FIG. 3 shows a side view of the Modular Topography Accessory (10), further detailing the interaction between Upper Surface (75), Lower Surface (78), and Outer Surface Profiles (32, 34). A Cutout (80) is shown extending through the Body (22), enabling mechanical fixation or weight reduction. This embodiment also introduces Bottom Protrusions (38, 38b), which may enhance adhesion or grip during use. These Bottom Protrusions may vary in shape, location, or material composition, and can be fixed or integrated.

This example demonstrates both adhesive (110) and mechanical attachment methods, with the Screw (100) shown penetrating the accessory via a hole. The Lower Surface profile (78) and Outer Surface Profile (32, 34) may exhibit curves, flat sections, or angular transitions, all of which can be optimized for aesthetic or performance purposes.

FIG. 4 presents a cross-sectional view along line A-A of the Modular Topography Accessory (10). The internal structure reveals a Cavity (70), a through-hole (60), and a recessed Cutout (80). Inserts (39, 39a) are shown within or adjacent to these features, demonstrating examples of molded and removable configurations. Insert (39a) illustrates an example designed for manual insertion and removal, whereas Insert (39) may be integrated during manufacturing.

This view further illustrates variable surface contours in Outer Surface Profiles (32, 34), which may include rounded, tapered, or faceted shapes depending on user preference or the type of board or object the accessory is mounted to. Traction Reduction Dimples (83, 41, 50a) are placed at strategic locations to minimize friction and may vary in number, depth, and distribution. Traction Protrusions (40, 50) in this embodiment may exhibit various geometries (e.g., cones, bumps) and elevations for targeted interaction with the rider's footwear or external surfaces.

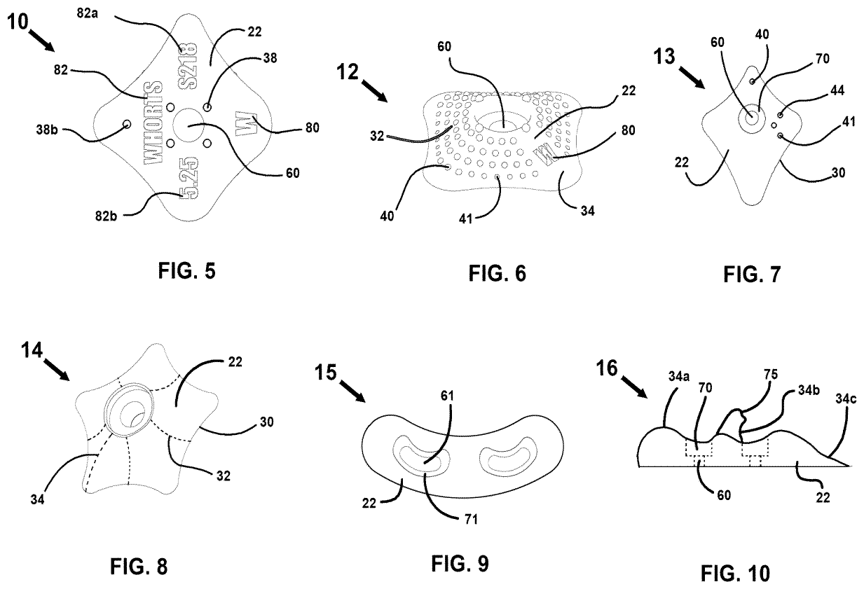

FIG. 5 offers a bottom view of the Modular Topography Accessory (10). The Cutout (80) and Hole (60) are visible, extending through the Body (22). Cavities (82, 82a, 82b) are shown recessed into the bottom surface, serving functional and informational purposes—such as grip enhancement, placement for branding, part identification, or dimensional labeling.

Bottom Protrusions (38, 38b) are illustrated in alternate configurations and may be integrally molded or separately attached. These features aid in physical connection to an object or provide surface interaction benefits, depending on the intended application. Material choices and shapes for these protrusions may vary and can include specialized textures or embedded Inserts for additional functionality.

FIG. 6 illustrates a perspective view of Modular Topography Accessory (12), showcasing a squarer overall shape compared to the form in FIG. 1. It includes consistent core features such as the Body (22), Outer Surface Profiles (32, 34), Hole (60), Cutout (80), Traction Protrusion (40), and Traction Reduction Dimple (41). This configuration highlights how the invention accommodates alternative geometry for different use cases or aesthetic preferences.

The figure emphasizes the modularity of the design, where variations in the body shape enable different contact zones and performance effects on surfaces like curbs, rails, or coping. The depicted surface features may be filled, removed, or substituted to fine-tune grip, traction, or interaction with external objects.

FIG. 7 offers a top-down view of Modular Topography Accessory (13), illustrating another variation in Body (22) shape. This configuration introduces Hole (44), a distinct geometry that may be used for mounting or inserting functional materials like wax or rubber. As with prior embodiments, the accessory may feature or omit elements such as Hole (60), Cavity (70), Traction Reduction Dimple (41), or Traction Protrusion (40), and these features may appear in differing shapes and placements.

This figure highlights the open design possibilities within the invention, with surface apertures optionally used for performance tuning, weight adjustment, or integration of other elements.

FIG. 8 depicts Modular Topography Accessory (14) from a perspective view, offering yet another variation in Body (22) and Outer Surface Profile (30, 32, 34). The configuration demonstrates the use of concave and convex profile elements to influence how the rider's foot or the board interacts with obstacles or environmental surfaces. These curvature-based modifications are especially useful for tricks requiring predictable adhesion or redirection, such as slides or flips.

By adjusting the Outer Surface Profiles, the user may emphasize either stability or mobility, making this variation particularly effective for tailoring board control.

FIG. 9 presents a top-down view of Modular Topography Accessory (15), distinguished by its elongated Hole (61) and Cavity (71). This design allows the accessory to slide or reposition without full removal of a mounting screw, adding flexibility in adjustment. The Body (22) exhibits a curved overall shape, differing from previous examples, which may help guide foot placement or provide edge contact during maneuvers.

This embodiment highlights adaptability in positioning and reshaping, allowing riders to configure attachments based on performance or ergonomic needs.

FIG. 10 shows a side view of Modular Topography Accessory (16), emphasizing a diverse set of Outer Surface Profiles (34a, 34b, 34c, 75) integrated into Body (22). One of the notable design features here is the Inner Curved Outer Surface Profile (34b), positioned to interact with external skate features like rails or ledges.

The inclusion of Hole (60) and Cavity (70) continues the theme of varied attachment options, while the range of heights and angles between profiles enables specialized function—such as locking into contours during slides or leveraging unique shapes for trick initiation. This figure reinforces the invention's versatility in adapting to both trick-specific and terrain-specific requirements.

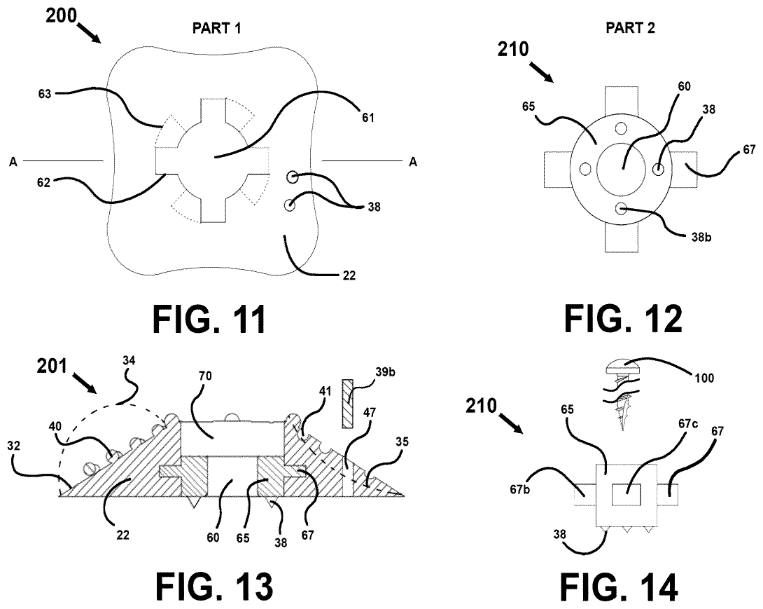

FIG. 11 shows a bottom view of Modular Topography Accessory (200), which introduces an optional Quick Release mechanism (part 1 of 2). The Body (22) features Hole (61) with additional Tab Cutouts (62) and designated Cavities (63) designed to accept locking features from a corresponding component. Bottom Protrusions (38) are included for added grip and stabilization when mounted to an object such as a skateboard deck.

This Quick Release system enables tool-free removal or swapping of components, adding a layer of user customization and efficiency. The Bottom Protrusions (38) shown here, while similar in purpose to those in prior figures, may vary in shape, number, and material depending on application needs.

FIG. 12 provides a bottom perspective view of Modular Topography Accessory (210), part 2 of 2 in the Quick Release configuration. The Body (65) includes Locking Tabs (67), Hole (60), and Bottom Protrusions (38, 38b), designed to interlock with FIG. 11 Cavities (63) and Cutouts (62) of part 1. During assembly, this lower component is screwed or adhered to the object, and the upper component (FIG. 11) is rotationally locked into place.

This embodiment emphasizes modular interchangeability, enabling different accessories to be mounted quickly and securely using various locking geometries, including tab-locking and threaded alternatives.

FIG. 13 presents a cross-sectional view (along line A-A) of the combined Quick Release system depicted in FIGS. 11 and 12. The upper component (Body 22) includes Cavity (70), Outer Surface Profile (32), and surface elements such as Traction Protrusions (40) and Traction Reduction Dimples (41). An Insert (39b) is illustrated within the structure, which may be fixed or removable through a secondary Hole (47).

The lower component Body (65) includes Hole (60), Locking Tab (67), and Bottom Protrusion (38), providing the mating mechanism to the upper part. This figure clarifies how locking and surface features are integrated into both parts of the Quick Release system while preserving overall modularity.

FIG. 14 offers a side view of Modular Topography Accessory (210), part 2 of 2, as mounted to a surface via Screw (100). It illustrates multiple Locking Tabs (67, 67b, 67c) engaging with corresponding FIG. 11 Cavities (63) of part 1 to form a secure connection. Bottom Protrusions (38) enhance attachment integrity and may also provide a tactile interface with the mounting surface.

This figure further supports the accessory's swappable nature, enabling users to

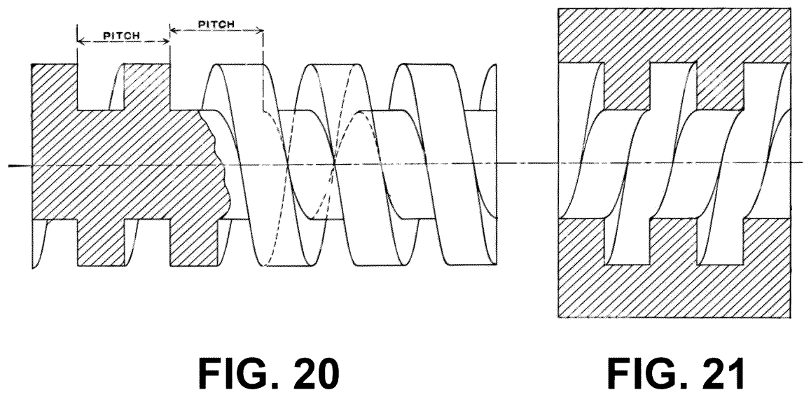

interchange accessories with varied profiles, textures, or materials based on riding conditions or trick requirements. An optional screw-based alternative to the locking tabs is introduced in FIGS. 20 and 21.

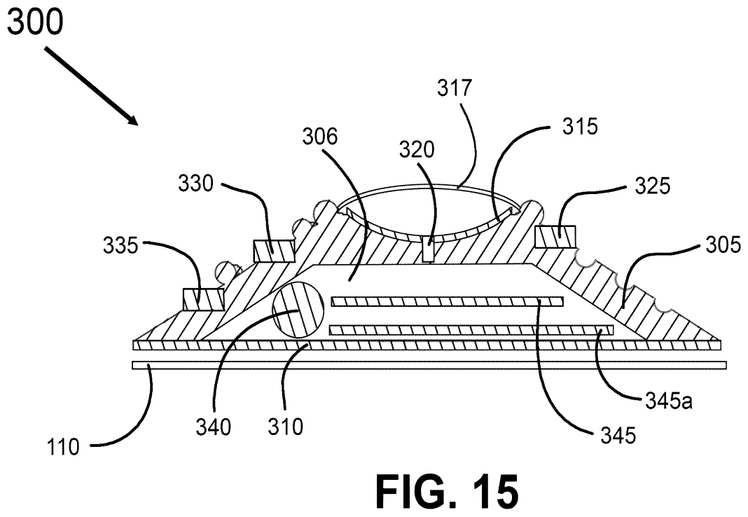

FIG. 15 provides a cross-sectional view of Modular Topography Accessory (300), illustrating an embodiment with integrated electronics. The Body (305) contains Cavity (306) designed to house components such as Computer Motherboards (345, 345a), Rechargeable or Non-Rechargeable Battery (340), LEDs (320, 325), a Mirror (315), and a Lens (317) for focused or diffused lighting. Additional features include a Switch (330), USB Port (335), and Bottom Plate (310), which may be sealed for waterproofing.

The accessory supports internal wiring pathways and sensor integration (e.g., accelerometers, gyroscopes, pressure or motion sensors), enabling interaction with external devices via wireless communication protocols like Bluetooth, RFID, NFC, or WiFi. Adhesive (110) is shown as a mounting method, though others may also be used.

This configuration opens functionality beyond physical interaction, enabling real-time data collection, lighting effects, or app-based feedback for performance enhancement.

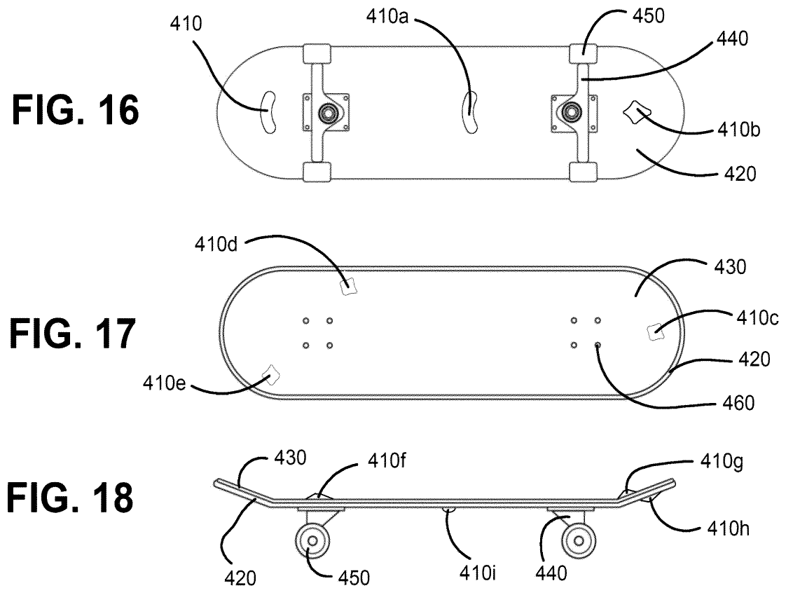

FIG. 16 illustrates a bottom view of a skateboard Deck (420) with three Modular Topography Accessories (410, 410a, 410b) mounted beneath it, shown in relation to the Trucks (440) and Wheels (450). This configuration demonstrates how multiple accessories may be positioned to interact with external obstacles such as rails, ledges, or curbs during slides or grinds.

The accessories feature Traction Reduction Dimples designed to minimize friction, and may include Inserts composed of materials such as wax, rubber, plastic, or metal to modify sliding characteristics. These bottom-mounted accessories allow for enhanced locking, sliding, and directional control during advanced maneuvers. The depicted configuration is one of many possible placements and combinations enabled by the modular design.

FIG. 17 shows a top view of the skateboard Deck (420) with three Modular Topography Accessories (410c, 410d, 410e) mounted to the upper surface using screws. Bolts (460) used to secure the deck to the trucks are also visible. Griptape (430) may or may not be present, depending on user preference. The Modular Topography Accessories may go above or below the grip tape.

This example highlights how top-mounted accessories contribute to performance by enhancing kick-off points used during trick initiation, such as ollies, flips, and spins. The accessories may include Traction Protrusions for grip and Inserts made from various materials for tactile or performance benefits. Each accessory can be shaped or textured to align with the rider's specific needs for foot placement and maneuver control.

FIG. 18 provides a side view of a skateboard Deck (420) featuring Modular Topography Accessories mounted both on the top (410f, 410g) and underside (410h, 410i). This arrangement demonstrates how accessories can be used simultaneously for both traction and sliding performance, depending on placement.

The top-mounted accessories assist with foot stabilization and trick initiation, while the bottom-mounted ones serve to interact with obstacles, lock into contours, or enable smooth sliding transitions. The deck also includes Trucks (440), Wheels (450), and Griptape (430). Accessories may introduce functional contours or bumps to the board surface, allowing precise foot targeting and visual cues for complex tricks.

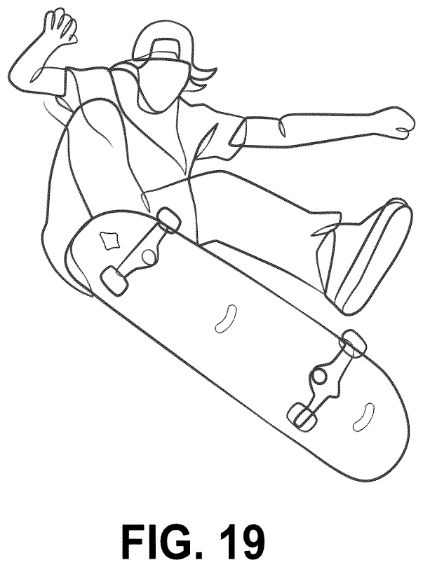

FIG. 19 depicts a skateboarder executing a flip trick using a skateboard equipped with Modular Topography Accessories. This action-based view illustrates how the accessories—mounted on both the top and bottom surfaces—assist in trick performance by enhancing grip, control, and flick response.

Top-mounted accessories engage with the rider's shoes to increase traction during the initiation and execution of flips, while bottom-mounted elements help guide and stabilize the board during airborne rotation or interaction with obstacles. The combined use of varied textures, profiles, and Inserts demonstrates the invention's role in optimizing trick mechanics and board control across multiple surfaces and environments.

FIG. 20 presents an alternate Quick Release mechanism in which the inner shell of the Modular Topography Accessory includes a threaded screw feature. This version is compatible with the accessory structure shown in FIG. 12 (part 2 of 2) and offers a screw-based locking alternative to the tab-locking mechanism illustrated in FIG. 11.

This embodiment simplifies user attachment by allowing rotation and thread engagement rather than tab alignment, offering an alternative for users who prefer tool-based installation or more rigid locking performance.

FIG. 21 shows a further alternate Quick Release configuration, this time integrating a threaded screw into the outer shell of the accessory—intended to interface with part 1 of 2 from FIG. 11. Like the previous figure, this design eliminates the need for locking tabs and cavities, instead favoring a threaded coupling system.

Together, FIGS. 20 and 21 offer interchangeable options within the same modular system, supporting multiple attachment styles—tab-lock, screw-thread, or hybrid—and expanding usability across different rider preferences and equipment setups.

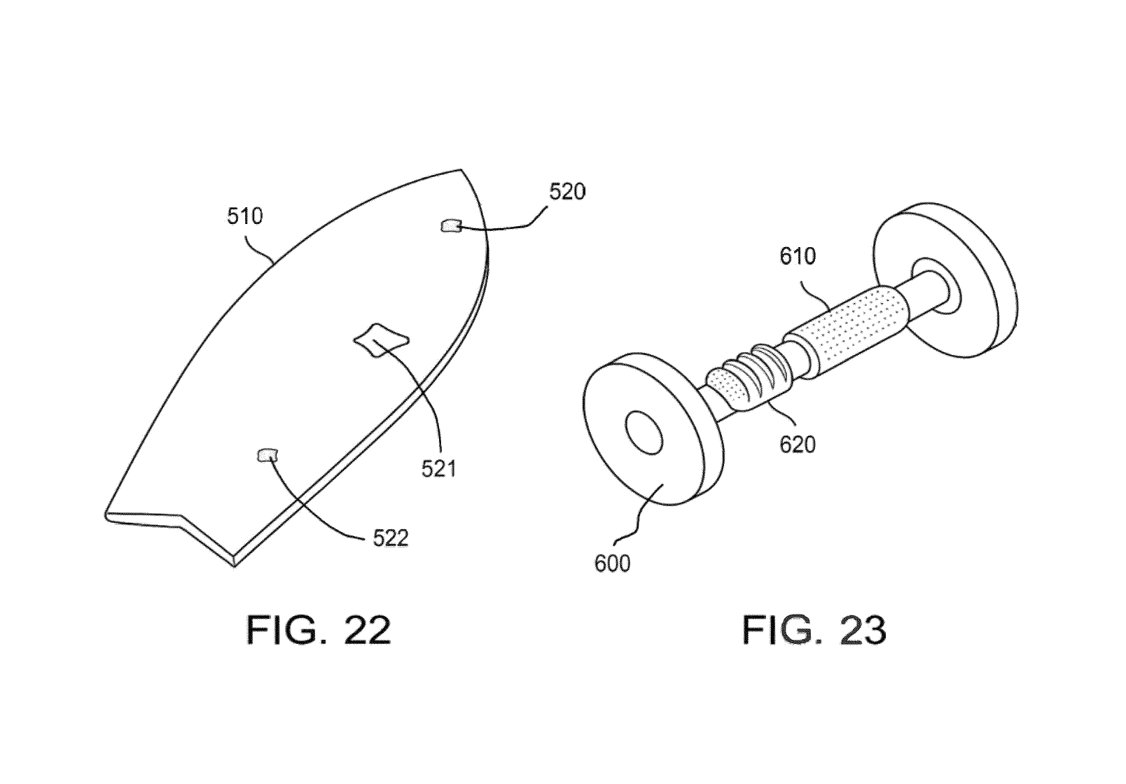

FIG. 22 depicts a surfboard platform (510) in top and side perspectives, showing Modular Topography Accessories (520, 521, 522) arranged in common foot placement zones. These accessories may include raised arch pads, concave heel wells, and wax-compatible Inserts to improve grip, balance, and control during maneuvers such as carves or bottom turns.

Installation methods may include UV-curable resin, pressure-sensitive adhesive, or quick-connect attachment. The layout is symmetrical to accommodate both regular and goofy-footed riders. This example expands the invention's application into aquatic boardsports, utilizing the same modular principles for traction, ergonomics, and customizability.

FIG. 23 illustrates a dumbbell or ergonomic fitness handle (600) fitted with Modular Topography Accessories (610, 620) along the grip zone. These components may include interchangeable rubberized Inserts, textured pads, or contoured overlays. Their underside is shaped to conform to the curvature of the handle, ensuring proper alignment and user comfort.

These grip-enhancing accessories are adaptable to a range of products beyond skateboards or boardsports—such as gym equipment, power tools, or consumer products—where improved tactile response, vibration dampening, or ergonomic fit may benefit the user. Materials and textures can be selected based on application-specific demands, such as moisture resistance or soft-touch comfort.

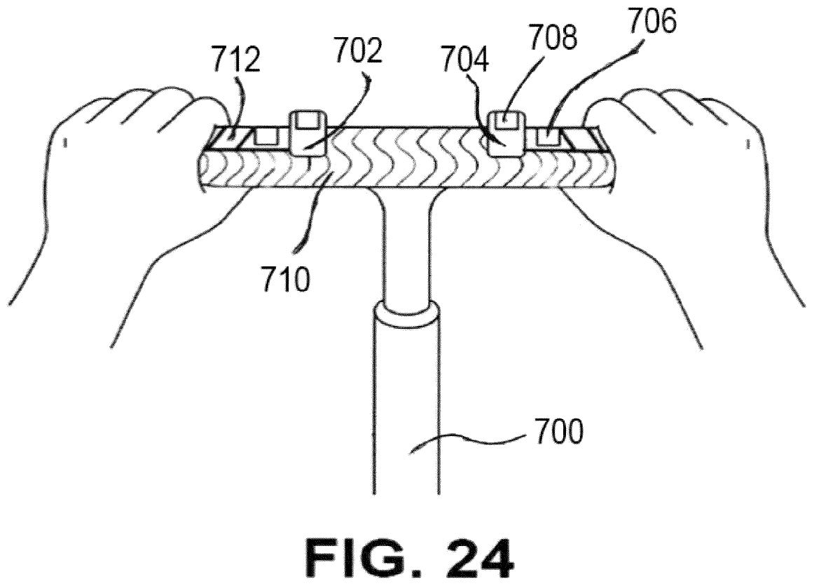

FIG. 24 illustrates an embodiment of a training handlebar assembly (700) suitable for use in fitness and ergonomic training environments, such as a rowing machine, stationary bicycle, exercise bar, or weightlifting system. The handlebar includes a pre-installed grip (710), which may provide a baseline textured surface or cushioning. Affixed over portions of the handlebar are two Modular Topography Accessories (702, 704), each positioned within user contact or grip zones.

Each modular accessory may include integrated grip guides (712), which define optimal hand placement areas through raised contours or recessed channels, and may also house embedded sensors for enhanced grip detection or tactile control. These grip guides (712) can improve ergonomic consistency while aiding users in developing proper posture and symmetry during movement.

The Modular Topography Accessories are further equipped with pressure sensors (706) and LED feedback indicators (708) configured to provide real-time sensory feedback. The sensors (706) are adapted to detect biomechanically optimal hand placement or grip force thresholds. When the user's hands align with a pre-calibrated ergonomic posture or grip zone, the LEDs (708) illuminate, confirming proper alignment and technique.

In alternative embodiments, the accessories may include accelerometers, gyroscopes, or multi-axis orientation sensors for tracking angular positioning, balance, and equipment alignment. For example, in weightlifting contexts, the embedded sensors may detect whether the bar remains level during lifts, while in power tool or drill applications, the sensors may confirm correct pitch and yaw during repetitive or overhead tasks.

In other embodiments, the modular accessories may include direct peer-to-peer

communication capabilities—either wireless (e.g., Bluetooth, BLE, Zigbee, Wi-Fi Direct, NFC) or wired (e.g., USB, serial, or analog connections)—enabling accessory-to-accessory interaction without requiring an external hub or controller. Each accessory may include a communication module configured to facilitate inter-accessory data exchange, sensor synchronization, and coordinated feedback delivery across the system. This architecture may support real-time data sharing, synchronized lighting patterns, haptic feedback coordination, and collaborative sensor calibration across multiple attachment points.

For example, when one accessory detects a threshold condition (e.g., improper grip, excessive pressure, unbalanced force distribution), it may trigger a corresponding visual or haptic response in another accessory positioned elsewhere on the platform. This distributed network of modular elements enables multi-point coordination, adaptive response behavior, and dynamic reconfiguration of training or feedback systems. In rehabilitation or fitness training use cases, one accessory positioned on a left-side grip may alert its counterpart on the right-side grip to guide symmetrical placement, posture alignment, or bilateral force application.

Such inter-accessory wireless communication expands the scope of functionality for the system, transforming isolated surface elements into an intelligent, collaborative grid of user feedback devices. This networked configuration may optionally communicate with mobile apps, cloud systems, or external displays for logging, analysis, or remote coaching.

This sensory feedback may be used for training, coaching, rehabilitation, or home fitness optimization, enabling users to self-correct form and enhance motor learning through visual or haptic cues. Such an embodiment extends the function of the Modular Topography System beyond passive tactile interaction, establishing a dynamic interface that guides, reinforces, or corrects user behavior in real time based on sensor data and embedded signal responses.

In further embodiments, Modular Topography Accessories may serve not only as tactile modifiers but also as interactive guidance systems that assist users in achieving optimal posture, grip placement, or movement technique. These accessories may be integrated with In certain embodiments, the modular topography accessories may incorporate multi-modal feedback mechanisms, including, but not limited to:
visual indicators, such as LEDs that activate upon correct grip pressure or placement;
haptic actuators, configured to vibrate when improper positioning or asymmetry is detected;
auditory feedback modules, such as buzzers or tone generators that signal successful or incorrect alignment; and
dynamic lighting patterns, capable of illustrating guided movements, real-time motion sequences, or biomechanical feedback.

The embedded electronics may include pressure sensors, accelerometers, gyroscopes, capacitive touch sensors, or orientation modules. These sensors may be calibrated to detect biomechanically optimal positions or track angular movement and alignment of tools, handlebars, or body posture.

For example, in fitness or rehabilitation contexts, the Modular Topography Accessories may confirm correct form during lifts, identify improper shoulder or wrist angles, or guide symmetrical bilateral movements. In another example, accessories installed on a gaming controller or VR interface may guide finger placement using tactile pulses or dynamic LED lighting to support reduced fatigue and enhanced responsiveness.

In some configurations, the system may further include inter-accessory communication capabilities. Each accessory may be equipped with a peer-to-peer wireless module—such as Bluetooth, Zigbee, or NFC—enabling collaborative behavior across multiple elements. One accessory detecting a misalignment condition may trigger a haptic or lighting response in another, guiding users toward correction.

These interactive features transform the Modular Topography System from a passive grip enhancement into an active training interface, supporting self-correcting feedback loops, digital coaching, and improved learning outcomes in athletic, ergonomic, or rehabilitative environments.

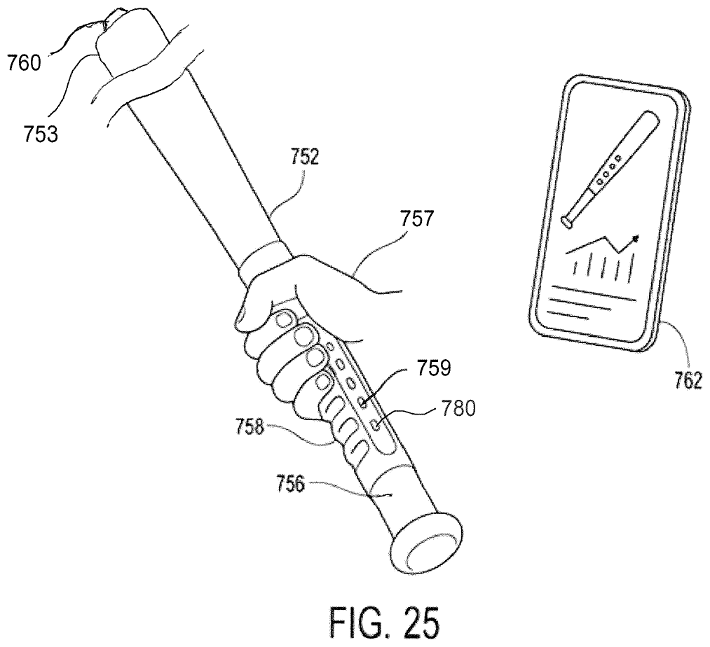

FIG. 25 illustrates a baseball bat system equipped with modular topography accessories and embedded electronic feedback components. The bat (752) includes a defined grip area (756) where a modular topography accessory (758) is affixed. A user's hand (757) is shown gripping the bat in this zone, interacting directly with the accessory's ergonomic finger ridges, which are designed to enhance tactile grip and user control. The accessory may optionally include embedded sensors for detecting grip force, hand position, or swing mechanics. A power switch (780) is integrated into the accessory to activate onboard electronic functions.

Within the same modular accessory, one or more embedded feedback components (759)—such as lights, speakers, or other signal devices—are configured to provide real-time user guidance. These may respond to grip pressure, swing orientation, or motion metrics, helping the user confirm or correct their grip dynamics or swing execution.

An additional optional modular topography accessory (760) is mounted near the top of the bat (753) and may communicate with the lower grip accessory to enable coordinated feedback across multiple zones of the bat. This upper accessory may provide additional sensory inputs or outputs, further enhancing swing diagnostics or training feedback.

The system is shown in communication with an external device (762), such as a smartphone, tablet, or cloud platform, which receives data wirelessly and presents feedback, analytics, or coaching cues to the user. This configuration enables biomechanically informed training, performance tracking, or real-time correction during batting practice or swing drills.

In further embodiments, the modular accessories may be integrated with rehabilitation tools or therapeutic grips. For example, in a wrist rehabilitation device or grip trainer, a modular topography accessory may include sensors that detect rotation angles, grip pressure, or motion smoothness. When a patient performs a motion within a defined therapeutic threshold—such as proper wrist pronation or extension—a feedback response is triggered, such as a progressive lighting sequence or vibration pulse to indicate compliance. This biofeedback enables real-time correction and positive reinforcement, enhancing motor control and recovery outcomes. Such functionality may be implemented using similar sensor-feedback modules described in FIGS. 24 and 25, illustrating the interchangeability of modular components across training, fitness, and rehabilitation platforms.

1. A modular topography accessory system, comprising:
(a) one or more attachable elements, each comprising:
(i) a body having an upper surface and a lower surface; and
(ii) one or more surface-modifying features disposed on at least one of the upper or lower surface, the features including, but not limited to: a protrusion, dimple, cavity, cutout, channel, or shape variation;
(b) a fastening mechanism configured to removably or permanently affix the attachable element to a user-contacting platform, such as a rideable board, handle, fitness device, gaming controller, tool, or wearable surface;
(c) wherein the surface-modifying features are configured to modulate grip, traction, tactile feedback, or slide characteristics; and
(d) wherein at least one attachable element is shaped, textured, contoured, or otherwise configured to align with a user-interaction region, including but not limited to: hand or foot placement zones, ergonomic contours, visual orientation guides, or motion-coordination regions.

2. The system of claim 1, wherein the attachable elements are positioned in user contact zones and include geometries configured to influence or enhance user interaction, including but not limited to posture, balance, tactile guidance, or motion.

3. The system of claim 1, wherein the attachable elements are configured for placement in one or more contact zones associated with user engagement, ergonomic alignment, or functional interaction.

4. The system of claim 1, wherein the fastening mechanism comprises one or more attachment methods, including but not limited to adhesive, mechanical fasteners, magnetic coupling, hook-and-loop material, interlocking tabs, UV-curable resin, quick-release mechanisms, or any other means suitable for removably or permanently affixing the attachable element to the platform.

5. The system of claim 4, wherein at least one attachable element comprises a UV-transmissive material and is configured to enable curing of a UV-curable resin layer beneath the element through integrated or external UV light sources, optionally including a built-in light emitter, power module, switch, or other curing-related features.

6. The system of claim 1, wherein the attachable elements are removable, replaceable, or reconfigurable post-installation to accommodate user preference, environmental conditions, wear patterns, or functional variation.

7. The system of claim 1, wherein the attachable elements include one or more surface profiles, including but not limited to raised, recessed, concave, convex, faceted, angular, or contoured geometries, configured to modify grip characteristics, tactile interaction, contact dynamics, or user feedback.

8. The system of claim 1, wherein the elements are: installed above or below a gripping layer; embedded during manufacturing; applied post-manufacture as aftermarket components; or otherwise integrated into the platform by any method suitable for enhancing user contact, grip, or interactivity.

9. The system of claim 1, wherein the elements are color-coded, patterned, textured, or visually labeled to convey functional characteristics, brand identity, instructional guidance, or zone alignment for user interaction.

10. The system of claim 1, wherein at least one attachable element includes interchangeable or fixed inserts comprising one or more materials, components, or devices configured to modify surface properties, user interaction, or system functionality, including but not limited to wax, foam, metal, elastomeric pads, or electronic modules.

11. The system of claim 1, wherein at least one attachable element includes a cavity configured to receive an electronic module or other component configured to enable sensing, signaling, feedback, or system communication.

12. The system of claim 11, wherein the electronic module comprises one or more components configured to provide sensing, signaling, motion detection, control, communication, or interactive functionality, including but not limited to sensors, lighting elements, switches, gyroscopes, or wireless communication devices.

13. The system of claim 12, wherein the module communicates wirelessly via one or more communication protocols including but not limited to Wi-Fi, Bluetooth, RFID, NFC, Zigbee, BLE, or equivalent technologies, and is powered by a rechargeable or non-rechargeable battery, wireless power transfer, or other suitable energy source.

14. The system of claim 1, wherein the embedded electronics include one or more of: a vibration module configured to emit haptic feedback; an audio module configured to emit tones or voice cues; or LED indicators, each responsive to user grip, posture, motion, force conditions, or other interaction states, and configured to guide ergonomic behavior, deliver feedback, or enable training assistance.

15. The system of claim 14, wherein each attachable element includes a wireless communication module configured to communicate directly with one or more other accessories in the system and trigger coordinated sensory or functional responses based on detected grip, posture, alignment, force, motion, or user interaction events.

16. The system of claim 15, wherein an event detected by one accessory triggers a coordinated response in another accessory within the system, the response comprising a visual, auditory, haptic, or other feedback mechanism configured to guide, alert, or influence user interaction.

17. The system of claim 1, wherein the embedded electronics are further configured to collect, store, or transmit interaction data or performance metrics to an external system, platform, or device for analysis, feedback, or longitudinal tracking related to training, rehabilitation, posture, or ergonomic optimization.

18. A kit for customizing a contact surface, the kit comprising:
(a) a plurality of modular topography elements, each configured to be affixed to a platform;
(b) optionally, one or more components selected from:
(i) fastening mechanisms,
(ii) tools for installation or removal,
(iii) curing devices, and
(iv) alignment guides;
(c) wherein at least one modular topography element includes a three-dimensional structure configured to influence pressure distribution, grip force, or contact angle during user interaction; and
(d) wherein at least one modular topography element comprises a cavity configured to receive an insert or embedded component, the insert or component comprising one or more materials, mechanisms, or devices configured to:
(i) alter surface characteristics,
(ii) provide user feedback,
(iii) enhance user interaction, or
(iv) extend system functionality,
including but not limited to physical fillers, structural modifiers, sensors, electronic modules, responsive materials, or communication elements.

19. The kit of claim 18, wherein the modular topography elements include one or more non-flat, three-dimensional structures configured to influence pressure distribution, grip force, contact angle, or other biomechanical factors during user interaction.

20. A method of customizing a contact surface, comprising:
(a) selecting one or more modular topography elements;
(b) affixing the selected elements to a platform using a fastening mechanism;
(c) optionally adjusting placement, orientation, or configuration of the elements based on user preference or activity; and
(d) optionally detecting user interaction via one or more embedded sensors or input-responsive elements in the modular topography elements and generating visual, haptic, or auditory feedback in response to grip behavior, force thresholds, posture, or user alignment.
